(19) United States
(12) Patent Application Publication
(10) Pub. No.: US 2019/0072072 A1
(43) Pub. Date: Mar. 7, 2019

(54) VARIABLE SPEED CONTROL OF WIND TURBINE GENERATOR BASED ON ESTIMATED TORQUE

(71) Applicant: ENVISION ENERGY USA LTD., Houston, TX (US)

(72) Inventor: Haijun Fang, Houston, TX (US)

(21) Appl. No.: 15/696,974

(22) Filed: Sep. 6, 2017

(51) Int. Cl. F03D 7/02; F03D 1/06; F03D 7/04; F03D 17/00

(52) U.S. Cl. CPC F03D 7/0276; F03D 1/06; F03D 9/25; F03D 7/0224; F03D 17/00; F03D 7/044

(57) ABSTRACT

A system for controlling a wind turbine generator includes a rotor blade assembly having rotor blades and a pitch actuator to control a pitch of the rotor blades, a gear box coupled to the rotor blade assembly, a power generator coupled to the gear box, and a main controller. The main controller is configured to control the aerodynamic torque applied on the rotor blades based on pitch control commands, and separately configured to control a generator speed of the power generator based on torque control commands. The system further includes a pitch controller configured to receive pitch calculation information from the main controller, calculate the pitch control commands, and return the pitch control commands to the main controller. The system further includes a torque controller configured to receive torque calculation information from the main controller, calculate the torque control commands, and return torque control commands to the main controller.

### BACKGROUND OF THE DISCLOSURE

### Field of the Disclosure

Embodiments of the present disclosure relate generally to the field of power generation from wind turbines, and more particularly to a variable-speed control of a wind turbine generator.

### Discussion of Related Art

As an alternative to fossil fuel energy sources, including oil, natural gas, and coal, which are slowly depleting and produce emissions that affect the environment, renewable energy sources provide a cleaner means to obtain power. Wind turbines have been receiving attention for decades, and are viewed as a key source of renewable energy. Because of the important role of wind power in the energy market, wind turbines have been designed and improved for higher energy production and lower cost.

Existing systems provide methods to harness electrical power from wind currents using turbines, and some systems provide for methods to manipulate the pitch of blades of a wind turbine by turning the blades about their longitudinal axis, or the torque of a generator of the wind turbine, to attain more efficient energy production. A conventional variable-speed wind turbine construction is shown in FIG. 1. As shown, a wind turbine, generally indicated at 10, includes a wind turbine tower 12, which is mounted on a solid surface, such as a foundation 14. The wind turbine 10 further includes a nacelle 16 provided at an upper end of the wind turbine tower 12, the nacelle housing internal working components of the wind turbine. A hub 18 is rotatably mounted on the nacelle 16, the hub having a plurality of blades, each indicated at 20, spaced equidistant from one another outwardly from the hub. As shown, the wind turbine 10 includes three blades 20; however, any number of blades can be provided. The blades 20 are mounted to the hub 18, which is installed on a drive shaft connecting a drive-train system 22 inside the nacelle 16. The blades 20 and the hub 18 are together identified as a rotor system or rotor blade assembly.

As mentioned, the nacelle 16 is positioned at the top of the wind turbine tower 12, and rotates axially around the tower to make the rotor system sweep an area facing the wind direction for maximal wind energy extraction. The drive-train system 22 includes a power generator from which electricity is produced. A gear box is provided as part of a drive-train system 22 to achieve a higher generator speed for a better efficiency in energy conversion. A wind vane and an anemometer 23 can be located at the end of the nacelle 16. A control system or controller 24 and different types of sensors 26 are housed within the nacelle 16. The control system 24 processes inputs from sensors 26 and then the control commands, yaw commands, pitch commands and torque commands are calculated and sent to actuators of yaw control, pitch control and torque control associated with the rotor system and the power generator as described in greater detail below.

Typical variable speed wind turbines allow for the regulation of the generator speed by controlling the adjustment of blade pitch angles using a pitch actuator. Generator torque may also be regulated, allowing the generator to adjust the amount of torque it demands from the rotor system. FIG. 2 shows how rotor speed, torque and blade pitch angle change at different wind speeds according to typical variable speed wind turbines. Generally, if the system is in Region 1, where the wind speed is less than a cut-in wind speed, the generator speed is controlled at a minimal speed set point by pitch regulation. In this region, the torque is set to zero so no electricity outputs from the power generator. In Region 2 when the wind speed is greater than the cut-in wind speed, the pitch angle is set to its optimal value that is identified as “FinePitch.” Torque depends on the generator speed, Torque=kₒₚₜω², where kₒₚₜ is identified as the optimal gain and co is the generator speed. This torque control strategy helps to maximally extract energy from wind. Therefore, Region 2 is identified as optimal tracking stage. Region 2.5 is a transitional stage between Region 2 and Region 3. In Region 2.5, the rotor speed reaches its maximal value that is identified as rated speed. The pitch is still set to FinePitch. In this stage, a different torque control strategy is applied to regulate the generator speed around the rated speed. Proportional-integral-derivative (PID) control is a common control strategy applied in torque control. As wind speed increases and the torque reaches its maximal value, pitch starts to move and helps regulate the generator speed and this stage is identified as Region 3. According to this embodiment, the torque control and the pitch control are both regulating the generator speed regulation and work in Region 2.5 and Region 3, respectively.

Typically, as is shown in the previous figure, variable speed wind turbine control systems apply control strategies based on proportional-integral-derivative control, and the pitch and torque controls at different wind speeds are coupled to both regulate the generator speed. Ideally, the two control strategies are not enabled at the same time because the controls are operating in different regions, and the systems typically check the condition if the torque reaches its maximal value. However, in practice, wind speeds fluctuate rapidly between Region 2, Region 2.5, and Region 3; so fast, in fact, that torque control and pitch regulation are often enabled at the same times. A potential issue of this method is that pitch control and torque control regulate the generator speed in two separate control loops so that they may not coordinate well and desynchronize the system. For example, if the rotor speed is lower than the rated speed and the pitch angle is greater than FinePitch, the pitch will decrease to FinePitch. However, since pitch movement is slower than the adjustment in torque, the torque control output will decrease as well, and will effectively increase the rotor speed. This action will generate less power because of the reduction in torque control. Generator speed oscillation and even power oscillation may happen if the pitch regulation and torque control do not coordinate well. Such oscillation increases fatigue or extreme loads on a wind turbine. Moreover, the entire wind turbine control system may become unstable and need to be shut down for maintenance.

A need exists for a new strategy that decouples pitch regulation and torque control to improve generator speed regulation, while maintaining or improving the existing annual energy production and fatigue and extreme loads of the wind turbine system.

### SUMMARY OF THE DISCLOSURE

One aspect of the disclosure is directed to a system for controlling a wind turbine generator. In one embodiment, the system includes a rotor blade assembly including rotor blades and a pitch actuator to control a pitch of the rotor blades, a gear box coupled to the rotor blade assembly, a power generator coupled to the gear box, and a main controller coupled to the rotor blade assembly and the power generator. The main controller is configured to control the aerodynamic torque applied on the rotor blades based on pitch control commands, and separately configured to control a generator speed of the power generator based on torque control commands. The system further includes a pitch controller coupled to the main controller. The pitch controller is configured to receive pitch calculation information from the main controller, calculate the pitch control commands, and return the pitch control commands to the main controller. The system further includes a torque controller coupled to the main controller. The torque controller is configured to receive torque calculation information from the main controller, calculate the torque control commands, and return torque control commands to the main controller.

Embodiments of the system further may include configuring main controller to decouple the pitch control commands from the torque control commands. The pitch calculation information may include at least a wind speed, and an actual rotor speed. Calculating the pitch control commands may involve receiving the pitch calculation information to determine an estimated aerodynamic torque. Calculating the estimated aerodynamic torque may involve using an estimated low-speed shaft torque. Calculating the pitch control commands may include utilizing PID control. The pitch controller may recursively determine the pitch control commands by comparing an estimated aerodynamic torque and an aerodynamic torque set point. The torque calculation information may include at least one of a wind speed, an actual electrical torque, an actual generator speed, a gear box loss table, and an actual rotor speed. Calculating the torque control commands may involve receiving the torque calculation information to determine an estimated high-speed shaft torque. Calculating the torque control commands includes utilizing PID control. A minimal torque value may be determined using an actual generator speed and an optimal gain. The torque controller may recursively determine the torque control commands by comparing an actual generator speed and a generator speed set point.

Another aspect of the disclosure is directed to a method of controlling a wind turbine generator. In one embodiment, the method comprises: controlling an aerodynamic torque applied on rotor blades based on pitch control commands; separately controlling a generator speed of a power generator based on torque control commands; receiving pitch calculation information from the main controller, calculating the pitch control commands, and returning the pitch control commands to the main controller; and receiving torque calculation information from the main controller, calculating the torque control commands, and returning torque control commands to the main controller.

Embodiments of the method further may include torque control commands that are parabolic when the generator speed reaches a set cut-in wind speed, and last until the generator speed reaches a maximum value. The torque control commands may be PID controls when the generator speed reaches the maximum value, and last until a rated wind speed level is met. The pitch control commands may be set to a constant angle, and last until the rated wind speed level is met. The pitch control commands may be PID controls when the rated wind speed level is met.

Yet another aspect of the disclosure is directed to a control for controlling a wind turbine generator. In one embodiment, the control includes a main supervisory system configured to manipulate a pitch angle of rotor blades of the wind turbine based on pitch control commands, and separately configured to regulate a generator speed of a power generator of the wind turbine based on torque control commands. The control further includes a pitch controller coupled to the main supervisory system. The pitch controller is configured to receive pitch calculation information from the main controller, calculate the pitch control commands, and return the pitch control commands to the main controller. The control further includes a torque controller coupled to the main supervisory system. The torque controller is configured to receive torque calculation information from the main controller, calculate the torque control commands, and return torque control commands to the main controller.

Embodiments of the control further may include configuring the main supervisory system to decouple the pitch control commands from the torque control commands. The pitch calculation information may include at least a wind speed, and an actual rotor speed. Calculating the pitch control commands may involve receiving the pitch calculation information to determine an estimated aerodynamic torque. Calculating the estimated aerodynamic torque may involve using an estimated low-speed shaft torque.

### BRIEF DESCRIPTION OF THE DRAWINGS

Aspects and embodiments of the disclosure are described in detail below with reference to the accompanying drawings. It is to be appreciated that the drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of a wind turbine in the form of a variable speed wind turbine;

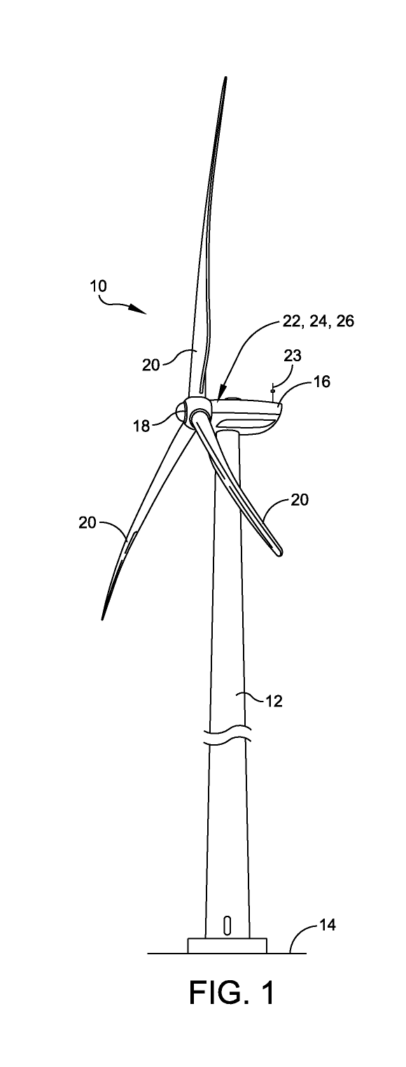

FIG. 2 is a graph showing generator speed, torque, and pitch angle responses at different wind speed;

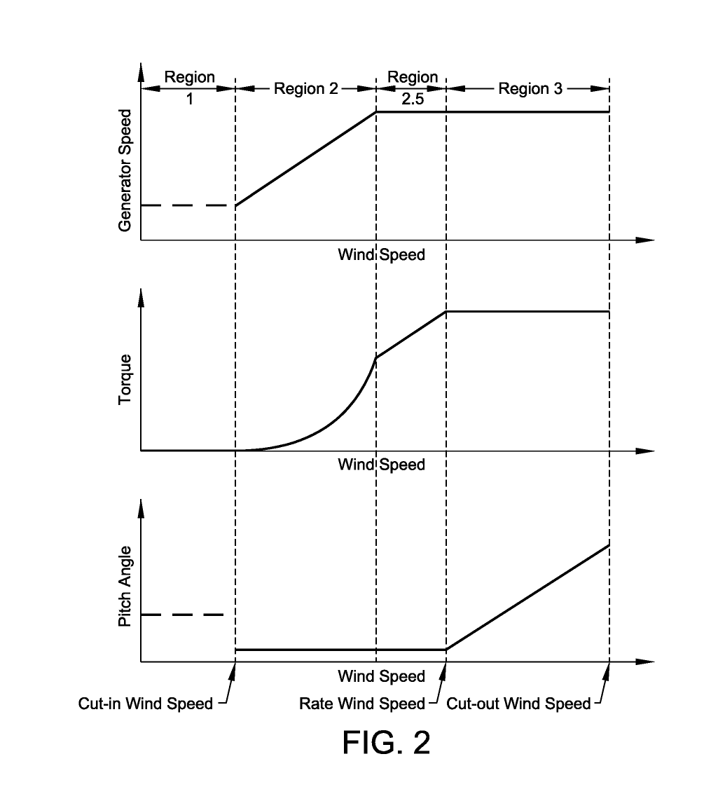

FIG. 3 is a block diagram of the control system architecture of a wind turbine;

FIG. 4 is a block diagram of the process of estimating the torque on a high-speed shaft;

FIG. 5 is a block diagram of the process of estimating the torque on a low-speed shaft;

FIG. 6 is a block diagram of the process of estimating the aerodynamic torque;

FIG. 7 is a schematic diagram illustrating a control method for pitch regulation;

FIG. 8 is a schematic diagram illustrating a control method for torque control;

FIG. 9 is a block diagram of the process of calculating the minimal torque value; and

FIG. 10 is a block diagram of a system upon which various embodiments of the disclosure may be implemented.

### DETAILED DESCRIPTION OF THE INVENTION

Embodiments of the present disclosure are directed to a new system, method, and control, to control a wind turbine generator. In embodiments of the present disclosure, pitch control is used to control the aerodynamic torque applied on the blades of a wind turbine, while torque control is for generator speed regulation. This decoupling increases efficiency in the power output of a wind turbine at increased wind speeds, while the turbine is turned to a single rotor plane facing the wind. This also limits any inefficiency in the system that may arise from coupling pitch and torque control at the same time. This method can help to improve the generator speed regulation. In simulation tests, the standard deviation of the generator speed can be reduced by 30% to 50% by applying the method in the present disclosure. Moreover, since aerodynamic torque on blades is controlled, thrust force on a wind turbine is controlled as well, which helps to reduce fatigue and extreme loads on a wind turbine. Simulation tests show that the fatigue loads at the tower base can be reduced by 8%.

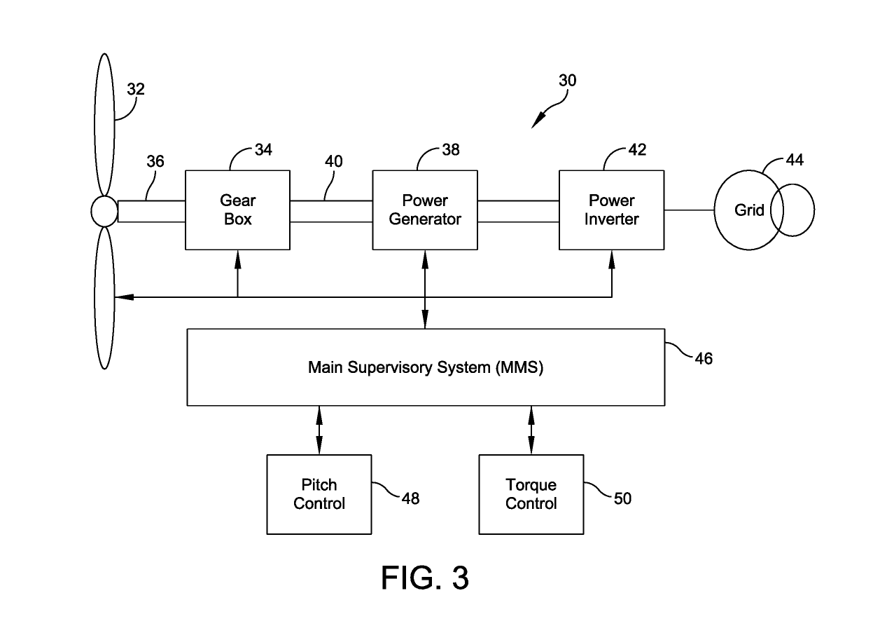

The internal structure and control system architecture of a wind turbine, generally indicated at 30, are shown in FIG. 3. As shown, blades 32 of the system 30 are coupled to a gear box 34 via a low-speed shaft 36, and the gear box is coupled to a power generator 38 via a high-speed shaft 40. Typical variable speed wind turbine systems, such as wind turbine 30, have a power inverter 42 coupled between the power generator 38 and the rest of an electrical grid 44. The power inverter 42 converts the variable frequency alternating current from the power generator 38 to direct current, and then converts it back to alternating current with a constant frequency, before it outputs the total system power to the grid 44. A main supervisory system (MSS) 46 connects with the blades 32, the gear box 34, the power generator 38 and the power inverter 42. In one embodiment, the MSS 46 is a controller configured to control the operation of the wind turbine 30, and may embody an embedded device of the wind turbine or peripheral device that is coupled to the wind turbine.

As shown in FIG. 3, the MSS 46 collects data from the key components of the wind turbine 30, and sends related data to a pitch control 48 and a torque control 50. The pitch control 48 and the torque control 50 each process the data from the MSS 46, and send back the pitch command and the torque commands, respectively, in the next control cycle. The MSS 46 sends the new commands to the pitch actuator on blades 32, and the torque commands to the power generator 38.

Before the pitch and torque controls 48, 50 transmit the control commands, the MMS 46 must first calculate the estimated torque on the high-speed shaft 40, the low-speed shaft 36, and the estimated aerodynamic torque, and then send this information as inputs to the pitch and torque controls 48, 50.

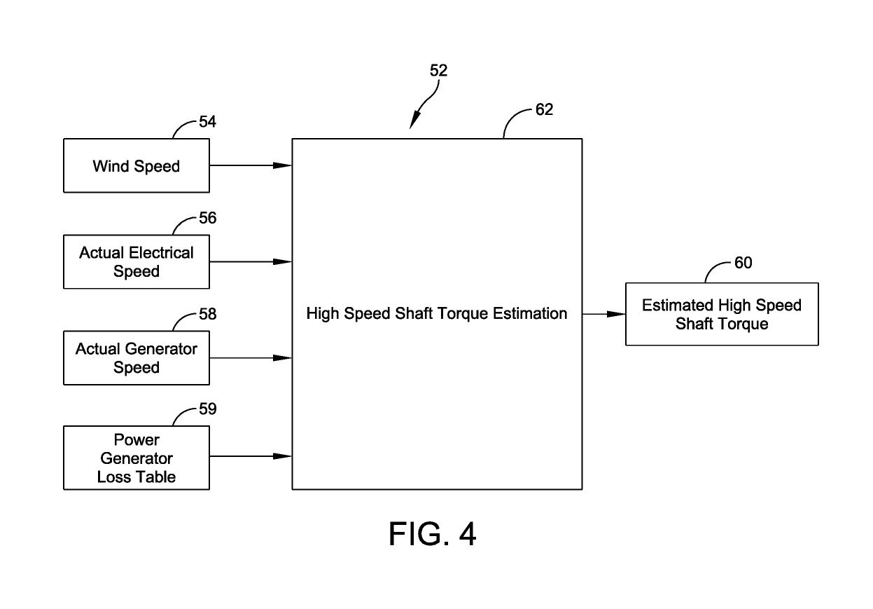

FIG. 4 shows a process, generally indicated at 52, of estimating the torque on the high-speed shaft 40, which depends on measured values of wind speed 54, actual electrical torque 56, and actual generator speed 58, the electrical power loss table 59, as calculated by the MSS 46. An estimated torque 60 on the high-speed shaft 40 is the output of the process after the wind speed 54, the actual electrical torque 56, the actual generator speed 58 and the electrical power lass table 59 are estimated by a high-speed shaft torque estimator 62.

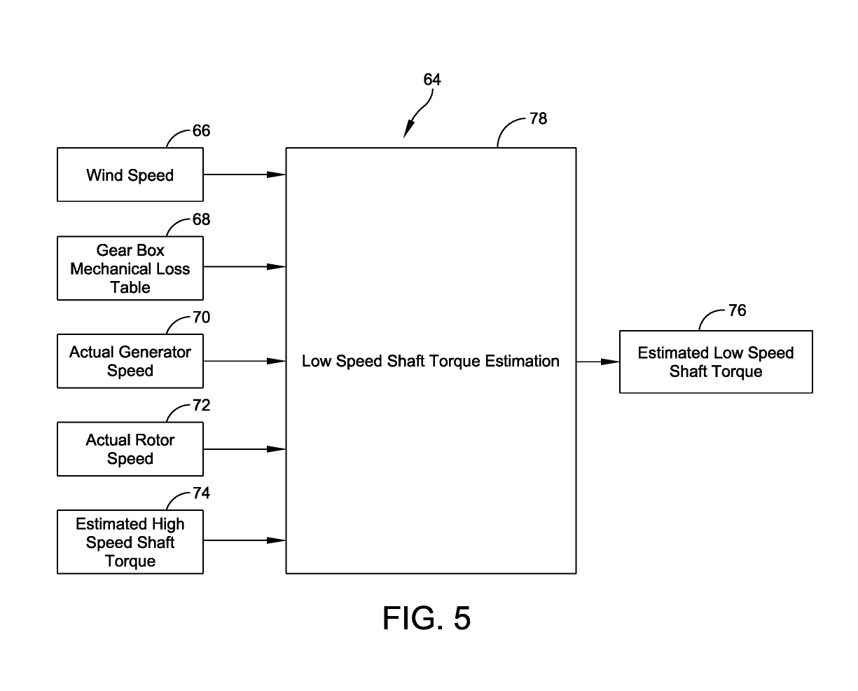

FIG. 5 shows a process, generally indicated at 64, of estimating the torque on the low-speed shaft 36, which depends on wind speed 66, gear box loss table 68, actual generator speed 70, actual rotor speed 72, and estimated torque 74 on the high-speed shaft (as calculated at 60), which are the inputs of the process, as calculated by the MSS 46. An estimated torque 76 on the low-speed shaft 36 is the output of the process after the wind speed 66, the gear box mechanical loss table 68, the actual generator speed 70, the actual rotor speed 72 and the estimated high-speed shaft torque 74 are estimated by a low-speed shaft torque estimator 78.

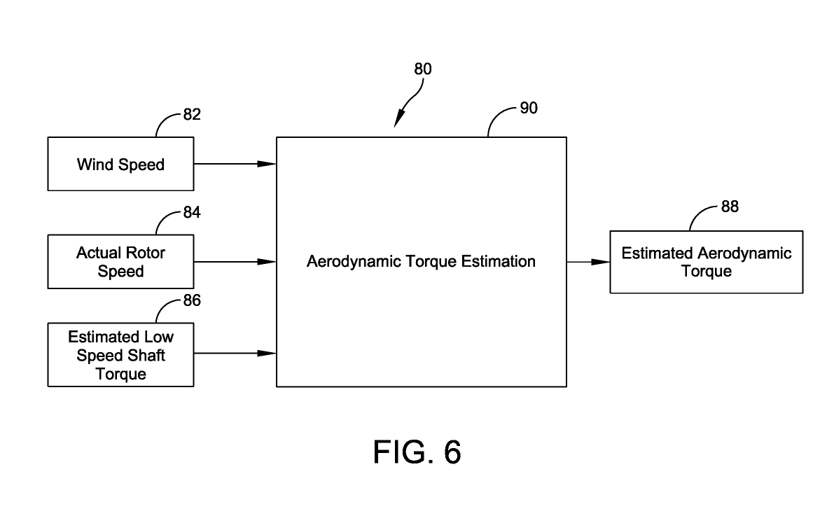

FIG. 6 shows a process, generally indicated at 80, of estimating the aerodynamic torque on the rotor blades, which depends on wind speed 82, actual rotor speed 84 and estimated torque 86 (as calculated at 76) on the low-speed shaft 36, which are the inputs of the process, as calculated by the MSS 46. An estimated aerodynamic torque 88 is the output of the process after the wind speed 82, the actual rotor speed 84 and the estimated low speed shaft torque 86 are estimated by an aerodynamic torque estimator 90.

Upon calculation, the MMS 46 outputs the estimated aerodynamic torque, the aerodynamic torque set point, the actual pitch angle and the actual generator speed as inputs to the pitch control 48, and the actual generator speed, the generator speed set point, the pitch angle, and the estimated torque on the high-speed shaft as inputs to the torque control 50.

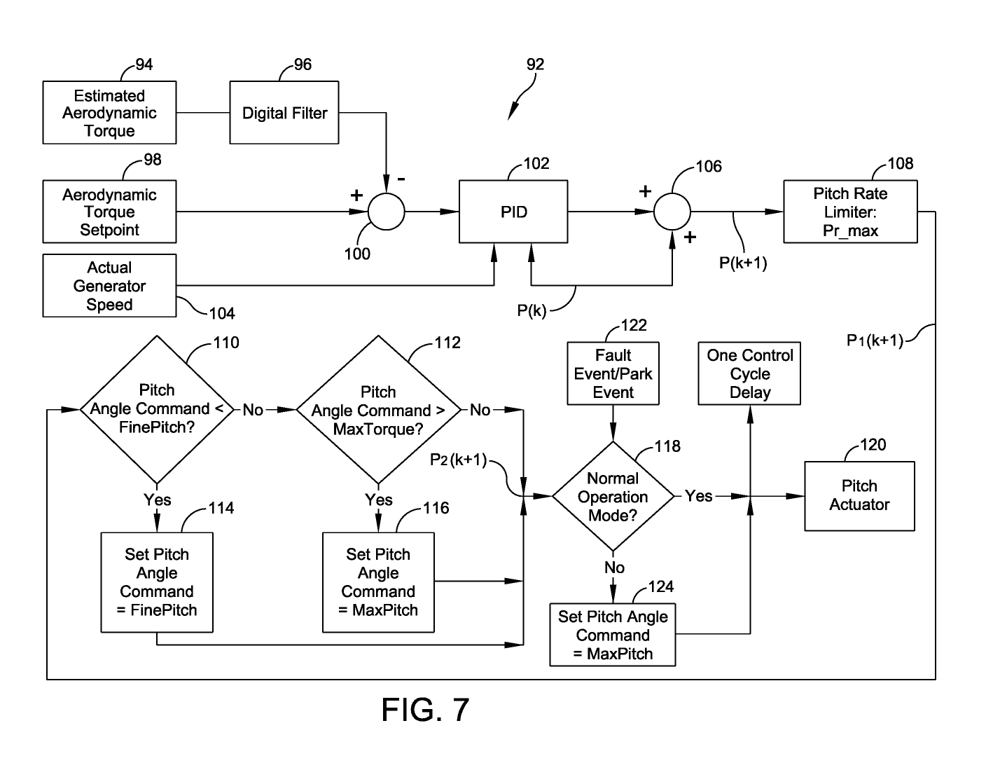

One embodiment of pitch regulation control, generally indicated at 92, of the present disclosure is depicted in FIG. 7. An estimated aerodynamic torque 94 is passed through a digital filter 96 to remove any unnecessary frequency components of the signal. The output of the digital filter 96 is the filtered estimated aerodynamic torque. An aerodynamic torque set point 98 is the value at which an aerodynamic torque level is controlled by the pitch regulation. A difference at 100 is determined between the filtered estimated aerodynamic torque 96 and the aerodynamic torque set point 98. This difference 100 is identified as the aerodynamic torque error. A proportional-integral-derivative (PID) control 102 is then applied to the aerodynamic torque error. The PID control 102 is a control loop, feedback mechanism that is commonly used in control systems. The PID control 102 continuously calculates an error value as the difference between a desired set point and a measured process variable, and applies a correction based on proportional, integral and derivative terms. Actual generator speed 104 is also fed to the PID control 102.

The proportional, integral and derivative gain can be constants or depend on a current pitch angle position, P(k), and an actual generator speed 104. The output of the PID control 102 is the incremental change of the pitch angle position. The current pitch angle P(k) is summed with the incremental change of the pitch angle at 106 and the result is identified as the new pitch angle, P(k+1), for the next control cycle. P(k+1) is subsequently sent to a pitch rate limiter 108 that limits the changing rate in pitch angle by Pr_max. The output of the pitch rate limiter 108 is identified as P₁ (k+1). Thereafter, P₁ (k+1) is compared to the values of FinePitch at 110 and MaxPitch at 112. The FinePitch 110 is the minimal pitch angle value, while the MaxPitch 112 is the maximal pitch angle value. If P₁(k+1) is greater than or equivalent to the FinePitch 110 and is less than or equivalent to the MaxPitch 112, the comparison result P₂ (k+1) is set to P₁ (k+1). If P₁ (k+1) is less than the FinePitch, the comparison result P₂ (k+1) is set to the FinePitch at 114. If P₁ (k+1) is greater than the MaxPitch 112, the comparison result P₂ (k+1) is set to the MaxPitch at 116.

Next, the comparison result P₂ (k+1) is input at 118 to check if the current operation mode is the normal operation mode. If it is, the final pitch angle for the next control cycle is P₂ (k+1) that is sent to a pitch actuator 120. Otherwise, there may be a fault event or a park event 122, in which case the pitch angle for the next control cycle is set to the MaxPitch at 124 and is sent to the pitch actuator 120. A one control cycle delay can be provided in the process.

One embodiment of pitch regulation control also can utilize the measured aerodynamic torque received from sensors on blades. The process 92 in FIG. 7 can still be used by replacing the estimated aerodynamic torque by the measured aerodynamic torque.

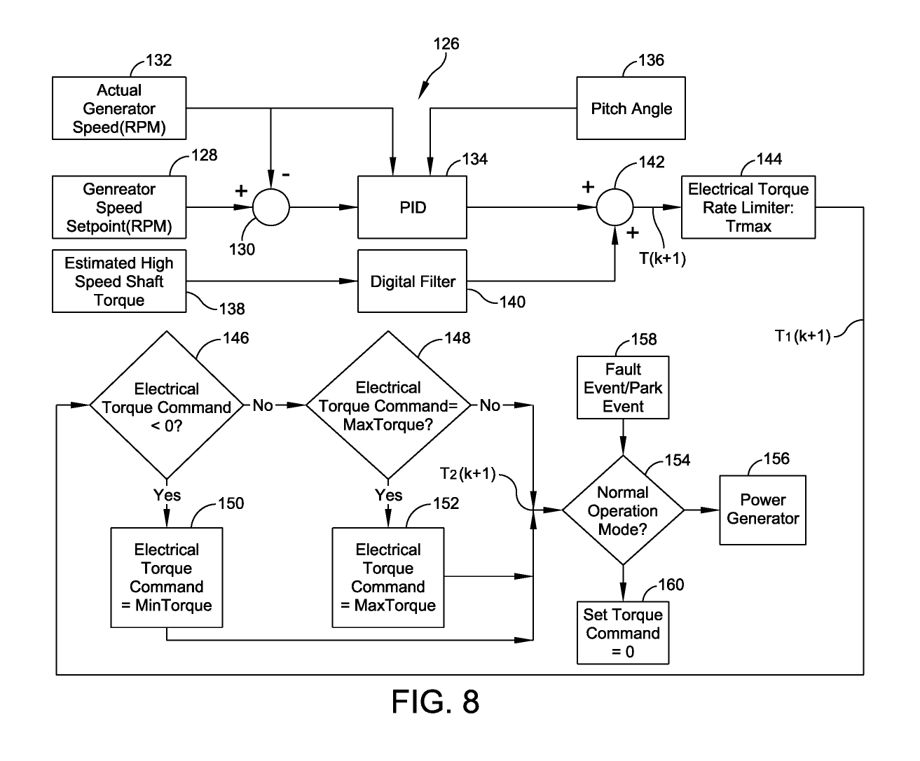

One embodiment of torque control, generally indicated at 126, of the present disclosure is shown in FIG. 8. A generator speed set point 128 is the value at which a generator speed is controlled by adjusting torque. A difference at 130 is determined between a measured or actual generator speed 132 and the generator speed set point 128. The difference 130 is identified as the generator speed error. Proportional-integral-derivative (PID) control 134 is applied to the generator speed error.

The proportional, integral and derivative gain can be constants or depend on a pitch angle 136 and the actual generator speed 132. An estimated torque 138 on the high-speed shaft 40 is passed through a digital filter 140 to remove any unnecessary frequency components. An output of the digital filter 140 is identified as the filtered estimated torque on the high-speed shaft 40. The filtered estimated torque on the high-speed shaft is added with the output of the PID at 142 and the result is the new torque command T(k+1) in the next control cycle. T(k+1) is input to the torque rate limiter 144 that limits the changing rate in torque by Tr_max. The output of the torque rate limiter 144 is identified as T₁ (k+1). T₁ (k+1) is then compared to MinTorque at 146 and MaxTorque at 148. MinTorque 146 is the minimal torque value while MaxTorque 148 is the maximal torque value. If T₁(k+1) is greater than or equivalent to MinTorque 146 and is less than or equivalent to MaxTorque 148, the comparison result T₂ (k+1) is equivalent to T₁(k+1). If T₁(k+1) is less than MinTorque, the comparison result T₂ (k+1) is set to MinTorque at 150. If T₂ (k+1) is greater than MaxTorque 148, the comparison result T₂ (k+1) is set to the MaxTorque at 152.

Next, the comparison result T₂ (k+1) is input at 154 to check if the current operation mode is the normal operation mode. If it is, the final torque command in the next control cycle is T₂ (k+1), and T₂ (k+1) is sent to a power generator 156. Otherwise, there may be a fault event or a park event 158, in which case the torque command in the next control cycle is set at 160 to zero and is sent to the power generator.

One embodiment of torque control also can utilize the measured torque received from sensors on high-speed shaft. The process 126 in FIG. 8 can still be used by replacing the estimated high-speed shaft torque by the measured high-speed shaft torque.

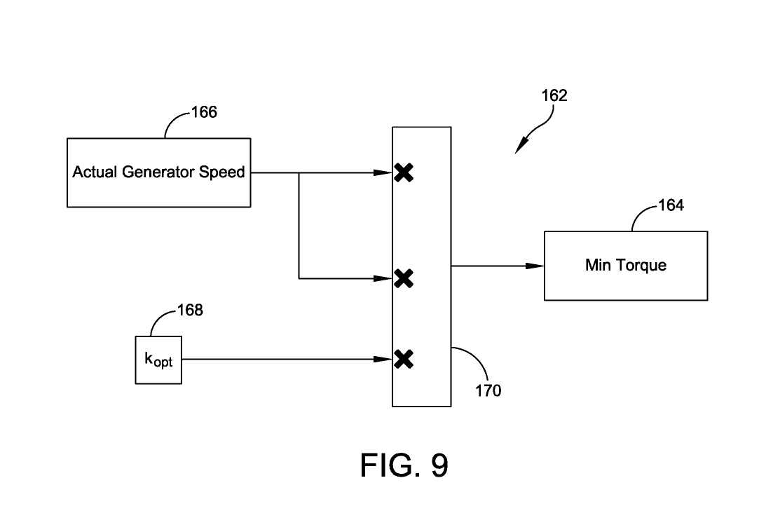

FIG. 9 depicts the process of calculating MinTorque, generally indicated at 162, which is a minimal torque value 164, used in the torque control process 126 illustrated in FIG. 8. The actual generator speed 166 is a first input and the optimal gain kₒₚₜ is a second input 168. The MinTorque value 164 is the multiplication of kₒₚₜ and the square of the measured generator speed at 170.

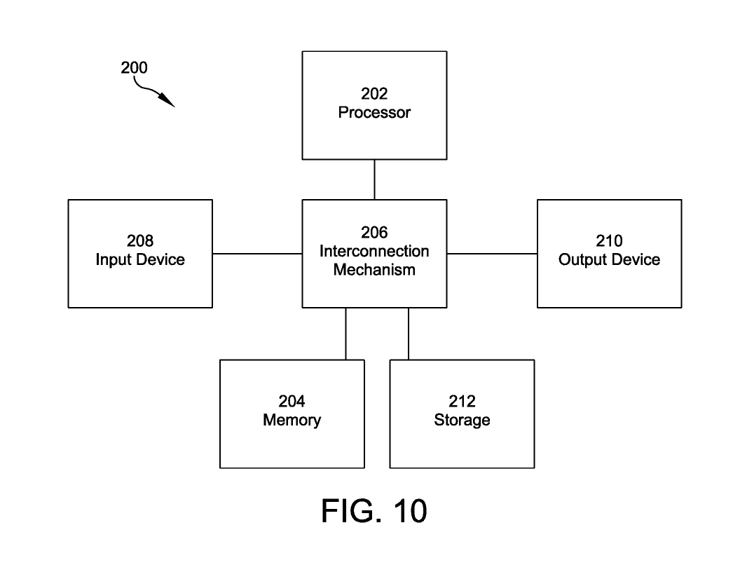

FIG. 10 illustrates an example block diagram of computing components forming a system 200 which may be configured to implement one or more aspects disclosed herein. For example, the system 200 may be communicatively coupled to the MSS or included within the MSS. The system 200 may also be configured to operate a bidirectional converter as discussed above.

The system 200 may include for example a computing platform such as those based on Intel PENTIUM-type processor, Motorola PowerPC, Sun UltraSPARC, Texas Instruments-DSP, Hewlett-Packard PA-RISC processors, or any other type of processor. System 200 may include specially-programmed, special-purpose hardware, for example, an application-specific integrated circuit (ASIC). Various aspects of the present disclosure may be implemented as specialized software executing on the system 200 such as that shown in FIG. 10.

The system 200 may include a processor/ASIC 202 connected to one or more memory devices 204, such as a disk drive, memory, flash memory or other device for storing data. Memory 204 may be used for storing programs and data during operation of the system 200. Components of the computer system 200 may be coupled by an interconnection mechanism 206, which may include one or more buses (e.g., between components that are integrated within a same machine) and/or a network (e.g., between components that reside on separate machines). The interconnection mechanism 206 enables communications (e.g., data, instructions) to be exchanged between components of the system 200. The system 200 also includes one or more input devices 208, which may include for example, a keyboard or a touch screen. The system 200 includes one or more output devices 210, which may include for example a display. In addition, the computer system 200 may contain one or more interfaces (not shown) that may connect the computer system 200 to a communication network, in addition or as an alternative to the interconnection mechanism 206.

The system 200 may include a storage system 212, which may include a computer readable and/or writeable nonvolatile medium in which signals may be stored to provide a program to be executed by the processor or to provide information stored on or in the medium to be processed by the program. The medium may, for example, be a disk or flash memory and in some examples may include RAM or other non-volatile memory such as EEPROM. In some embodiments, the processor may cause data to be read from the nonvolatile medium into another memory 204 that allows for faster access to the information by the processor/ASIC than does the medium. This memory 204 may be a volatile, random access memory such as a dynamic random access memory (DRAM) or static memory (SRAM). It may be located in storage system 212 or in memory system 204. The processor 202 may manipulate the data within the integrated circuit memory 204 and then copy the data to the storage 212 after processing is completed. A variety of mechanisms are known for managing data movement between storage 212 and the integrated circuit memory element 204, and the disclosure is not limited thereto. The disclosure is not limited to a particular memory system 204 or a storage system 212.

The system 200 may include a computer platform that is programmable using a high-level computer programming language. The system 200 may be also implemented using specially programmed, special purpose hardware, e.g. an ASIC. The system 200 may include a processor 202, which may be a commercially available processor such as the well-known Pentium class processor available from the Intel Corporation. Many other processors are available. The processor 202 may execute an operating system which may be, for example, a Windows operating system available from the Microsoft Corporation, MAC OS System X available from Apple Computer, the Solaris Operating System available from Sun Microsystems, or UNIX and/or LINUX available from various sources. Many other operating systems may be used.

The processor and operating system together may form a computer platform for which application programs in high-level programming languages may be written. It should be understood that the disclosure is not limited to a particular computer system platform, processor, operating system, or network. Also, it should be apparent to those skilled in the art that the present disclosure is not limited to a specific programming language or computer system. Further, it should be appreciated that other appropriate programming languages and other appropriate computer systems could also be used.

This disclosure is not limited in its application to the details of construction and the arrangement of components set forth in the following description or illustrated in the drawings. The disclosure is capable of other embodiments and of being practiced or being carried out in various ways. Also the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the scope of the disclosure. Accordingly, the foregoing description and drawings are by way of example only.

What is claimed is:

1. A system for controlling a wind turbine generator, the system comprising:
a rotor blade assembly including rotor blades and a pitch actuator to control a pitch of the rotor blades;
a power generator coupled to the rotor blade assembly;
a main controller coupled to the rotor blade assembly and the power generator, the main controller being configured to control the aerodynamic torque applied on the rotor blades based on pitch control commands, and separately configured to control a generator speed of the power generator based on torque control commands;
a pitch controller coupled to the main controller, the pitch controller being configured to receive pitch calculation information from the main controller, calculate the pitch control commands, and return the pitch control commands to the main controller; and
a torque controller coupled to the main controller, the torque controller being configured to receive torque calculation information from the main controller, calculate the torque control commands, and return torque control commands to the main controller.

2. The system of claim 1, wherein the main controller is configured to decouple the pitch control commands from the torque control commands.

3. The system of claim 1, wherein the pitch calculation information includes at least a wind speed, and an actual rotor speed.

4. The system of claim 3, wherein calculating the pitch control commands involves receiving the pitch calculation information to determine an estimated aerodynamic torque.

5. The system of claim 4, wherein calculating the estimated aerodynamic torque involves using an estimated low-speed shaft torque.

6. The system of claim 1, wherein calculating the pitch control commands includes utilizing PID control.

7. The system of claim 1, wherein the pitch controller recursively determines the pitch control commands by comparing an estimated aerodynamic torque and an aerodynamic torque set point.

8. The system of claim 1, further comprising a gear box coupled to the rotor blade assembly and the power generator, wherein the torque calculation information includes at least one of a wind speed, an actual electrical torque, an actual generator speed, a gear box loss table, and an actual rotor speed.

9. The system of claim 8, wherein calculating the torque control commands involves receiving the torque calculation information to determine an estimated high-speed shaft torque.

10. The system of claim 1, wherein calculating the torque control commands includes utilizing PID control.

11. The system of claim 1, wherein a minimal torque value is determined using an actual generator speed and an optimal gain.

12. The system of claim 1, wherein the torque controller recursively determines the torque control commands by comparing an actual generator speed and a generator speed set point.

13. A method of controlling a wind turbine generator, the method comprising:
controlling an aerodynamic torque applied on rotor blades based on pitch control commands;
separately controlling a generator speed of a power generator based on torque control commands;
receiving pitch calculation information from the main controller, calculating the pitch control commands, and returning the pitch control commands to the main controller; and
receiving torque calculation information from the main controller, calculating the torque control commands, and returning torque control commands to the main controller.

14. The method of claim 13, wherein the torque control commands are parabolic when the generator speed reaches a set cut-in wind speed, and last until the generator speed reaches a maximum value.

15. The method of claim 13, wherein the torque control commands are PID controls when the generator speed reaches the maximum value, and last until a rated wind speed level is met.

16. The method of claim 13, wherein the pitch control commands are set to a constant angle, and last until the rated wind speed level is met.

17. The method of claim 13, wherein the pitch control commands are PID controls when the rated wind speed level is met.

18. A control for controlling a wind turbine generator, the control comprising:
a main supervisory system configured to manipulate a pitch angle of rotor blades of the wind turbine based on pitch control commands, and separately configured to regulate a generator speed of a power generator of the wind turbine based on torque control commands;
a pitch controller coupled to the main supervisory system, the pitch controller being configured to receive pitch calculation information from the main controller, calculate the pitch control commands, and return the pitch control commands to the main controller; and
a torque controller coupled to the main supervisory system, the torque controller being configured to receive torque calculation information from the main controller, calculate the torque control commands, and return torque control commands to the main controller.

19. The control of claim 18, wherein the main supervisory system is configured to decouple the pitch control commands from the torque control commands.

20. The control of claim 19, wherein the pitch calculation information includes at least a wind speed, and an actual rotor speed, wherein calculating the pitch control commands involves receiving the pitch calculation information to determine an estimated aerodynamic torque, and wherein calculating the estimated aerodynamic torque involves using an estimated low-speed shaft torque.
